(19) United States
(12) Patent Application Publication
(10) Pub. No.: US 2025/0116451 A1
(43) Pub. Date: Apr. 10, 2025

(54) REFRIGERATOR

(71) Applicant: SAMSUNG ELECTRONICS CO., LTD., Suwon-si (KR)

(72) Inventors: Hojune JEON, Suwon-si (KR); Oungu LEE, Suwon-si (KR)

(73) Assignee: SAMSUNG ELECTRONICS CO., LTD., Suwon-si (KR)

(21) Appl. No.: 18/990,828

(22) Filed: Dec. 20, 2024

Related U.S. Application Data
(63) Continuation of application No. PCT/KR2023/008126, filed on Jun. 13, 2023.

(30) Foreign Application Priority Data
Aug. 3, 2022 (KR) 10-2022-0096987
Sep. 5, 2022 (KR) 10-2022-0112447

(51) Int. Cl. F25D 23/02; E05D 3/02; E05D 11/00; F25D 23/12

(52) U.S. Cl. CPC F25D 23/028; E05D 11/0054; E05D 11/0081; E05D 3/02; E05Y 2201/11; E05Y 2900/31; F25D 23/126; F25D 2323/024; F25D 2400/40

(57) ABSTRACT

A refrigerator includes: a main body including a storage chamber; a door configured to open or close the storage chamber; a hinge bracket supporting the door such that the door is rotatable about a hinge shaft with respect to the main body; a supply member including at least one of a wire or a pipe, and connected to the main body and the door; and a supply cover covering at least a portion of the supply member and a side of the hinge bracket, the supply cover being penetrated by the supply member, where the supply member includes a bending portion configured to be bendable according to opening or closing of the door, and where the supply cover includes a guide portion configured to support the bending portion in a state in which the door is closed.

### CROSS-REFERENCE TO RELATED APPLICATION(S)

This application is a continuation of International Application No. PCT/KR2023/008126, filed on Jun. 13, 2023, in the Korean Intellectual Property Receiving Office, which is based on and claims priority to Korean Patent Applications No. 10-2022-0112447, filed on Sep. 5, 2022 and No. 10-2022-0096987, filed on Aug. 3, 2022, in the Korean Intellectual Property Office, the disclosures of which are incorporated by reference herein in their entireties.

### SUMMARY

### 1. Field

This disclosure relates to a refrigerator.

### 2. DESCRIPTION OF RELATED ART

A refrigerator is an appliance including a main body having a storage chamber and a cool air supplier for supplying cool air to the storage chamber to keep foods fresh. The storage chamber may include a refrigerating chamber that is maintained at about 0° C. to 5° C. to keep foods refrigerated and a freezing chamber that is maintained at about 0° C. to 30° C. below zero to keep foods frozen. Generally, the front side of the storage chamber opens to put foods therein or take foods out, and the open front side of the storage chamber is opened and closed by a door.

The refrigerator repeatedly performs a cooling cycle of compressing, condensing, expanding, and evaporating refrigerants by using a compressor, a condenser, an expander, and an evaporator. The freezing chamber and the refrigerating chamber may be cooled by a single evaporator included in the freezing chamber, or separate evaporators may be included in the freezing chamber and the refrigerating chamber, respectively, to cool the freezing chamber and the refrigerating chamber independently.

In the door of the refrigerator, a water supply device, an electrical device (for example, a display device), etc. may be provided. Accordingly, the door may need to receive water or power from the main body.

### SUMMARY

Provided is a refrigerator with an improved structure to supply water or power to a component of the refrigerator, installed in the door.

Further provided is a refrigerator with an improved structure to guide a position of a wire or a pipe connected to a door and a main body.

Further provided is a refrigerator with an improved structure to prevent a wire or a pipe connected to a door and a main body from being damaged.

Further provided is a refrigerator with an improved structure to prevent interference with a movement of a wire or a pipe according to opening and closing of the door.

Additional aspects will be set forth in part in the description which follows and, in part, will be apparent from the description, or may be learned by practice of the presented embodiments.

According to an aspect of the disclosure, a refrigerator may include: a main body including a storage chamber; a door configured to open or close the storage chamber; a hinge bracket supporting the door such that the door is rotatable about a hinge shaft with respect to the main body; a supply member including at least one of a wire or a pipe, and connected to the main body and the door; and a supply cover covering at least a portion of the supply member and a side of the hinge bracket, the supply cover being penetrated by the supply member, where the supply member includes a bending portion configured to be bendable according to opening or closing of the door, and where the supply cover includes a guide portion configured to support the bending portion in a state in which the door is closed.

The supply cover may further include a through hole which the bending portion penetrates, where the through hole is between the guide portion and the hinge shaft.

The through hole may have a shape that opens in a front-rear direction of the main body.

The supply cover may further include an accommodating groove configured to accommodate at least a portion of the supply member at the side of the hinge bracket.

The supply cover may further include an accommodating groove opening along a perimeter of the accommodating groove, where at least a portion of the accommodating groove opening is in contact with the hinge bracket and the main body.

The supply cover may further include a bracket cover portion covering the side of the hinge bracket, and a body cover portion covering a side of the main body, where the accommodating groove includes: a body area provided inside the body cover portion, and a bracket area provided inside the bracket cover portion and having a wider width than the body area, and where the bracket area is between the body area and the guide portion.

The accommodating groove may further include a middle area between the body area and the bracket area, where the middle area is has a narrower width than the body area.

A lateral direction may be perpendicular to a direction in which the hinge shaft extends and a front-rear direction of the main body, where the main body includes a first side wall forming a surface adjacent to the hinge shaft in the lateral direction, and a second side wall forming a second surface in the lateral direction, and where the guide portion is oriented in a direction toward the second side wall from the first side wall with respect to an end of the accommodating groove toward the door.

The refrigerator may further include an elastic spring surrounding an outer circumferential surface of the bending portion, where the elastic spring is supported by the guide portion in the state in which the door is closed.

The door may include a door supply portion provided in a side of the door and connected to the supply member, where the refrigerator further includes a door cover member covering the door supply portion, and where the door supply portion and the door cover member are rotatable about the hinge shaft.

The guide portion may be between the door supply portion and the hinge shaft.

The door cover member may have a shape in which a side toward the guide portion is opened and a second side is closed.

The guide portion may have a curved shape.

The hinge bracket may include a door coupling portion coupled to the door, where the supply cover is fixed to the door coupling portion and the main body.

The supply cover may further include: a bracket cover portion opposite to the hinge bracket and covering the hinge bracket, a side wall portion extending from the bracket cover portion toward the hinge bracket and being in contact with the hinge bracket, and a bracket support portion extending from an end of the side wall portion in a direction parallel to the hinge bracket, wherein the bracket support portion is in contact with a side of the hinge bracket such that the supply cover is supported on the hinge bracket.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a perspective view of a refrigerator according to an embodiment of the present disclosure;

FIG. 2 is a schematic side cross-sectional view of a refrigerator according to an embodiment of the present disclosure;

FIG. 3 is a front view of a refrigerator according to an embodiment of the present disclosure;

FIG. 4 is an enlarged view of some components of a refrigerator according to an embodiment of the present disclosure;

FIG. 5 is an exploded rear view of some components of a refrigerator according to an embodiment of the present disclosure;

FIG. 6 is an exploded bottom view of some components of a refrigerator according to an embodiment of the present disclosure;

FIG. 7 is a bottom view of a refrigerator according to an embodiment of the present disclosure;

FIG. 8 is an exploded view of a supply cover and a door cover member in a refrigerator according to an embodiment of the present disclosure;

FIG. 9 shows some components of a refrigerator according to an embodiment of the present disclosure;

FIG. 10 shows a supply cover of a refrigerator according to an embodiment of the present disclosure;

FIG. 11 is an exploded view of a portion of a supply cover in a refrigerator according to an embodiment of the present disclosure;

FIG. 12 is a bottom view of a refrigerator while a door is closed according to an embodiment of the present disclosure;

FIG. 13 is a bottom view of a refrigerator while a door opens according to an embodiment of the present disclosure; and

FIG. 14 shows a state before a supply member is connected to a door in a refrigerator according to an embodiment.

### DETAILED DESCRIPTION

Hereinafter, example embodiments of the disclosure will be described in detail with reference to the accompanying drawings. The embodiments described herein are example embodiments, and thus, the disclosure is not limited thereto and may be realized in various other forms. The terms including technical or scientific terms used in the disclosure may have the same meanings as generally understood by those skilled in the art.

Also, like reference numerals or symbols denoted in the drawings of the present specification represent members or components that perform the substantially same functions.

Also, the terms used in the present specification are used for describing the embodiments, not for the purpose of limiting and/or restricting the present disclosure. The singular forms “a,” “an,” and “the” include plural referents unless the context clearly dictates otherwise. It will be understood that when the terms “includes,” “comprises,” “including,” “comprising,” “has,” “having,” and the like when used in this specification, specify the presence of stated features, figures, steps, operations, components, or combinations thereof, but do not preclude the presence or addition of one or more other features, figures, steps, operations, components, members, or combinations thereof.

Also, it will be understood that, although the terms including ordinal numbers, such as “first”, “second”, etc., may be used herein to describe various components, these components should not be limited by these terms. These terms are only used to distinguish one component from another. For example, a first component could be termed a second component, and, similarly, a second component could be termed a first component, without departing from the scope of the present disclosure. As used herein, the term “and/or” includes any and all combinations of one or more of associated listed items.

Meanwhile, in the following description, the terms “up-down direction”, “lower side”, “front-rear direction”, etc. are defined based on the drawings, and the shapes and positions of the components are not limited by the terms.

Hereinafter, the embodiments of the present disclosure will be described in detail with reference to the accompanying drawings.

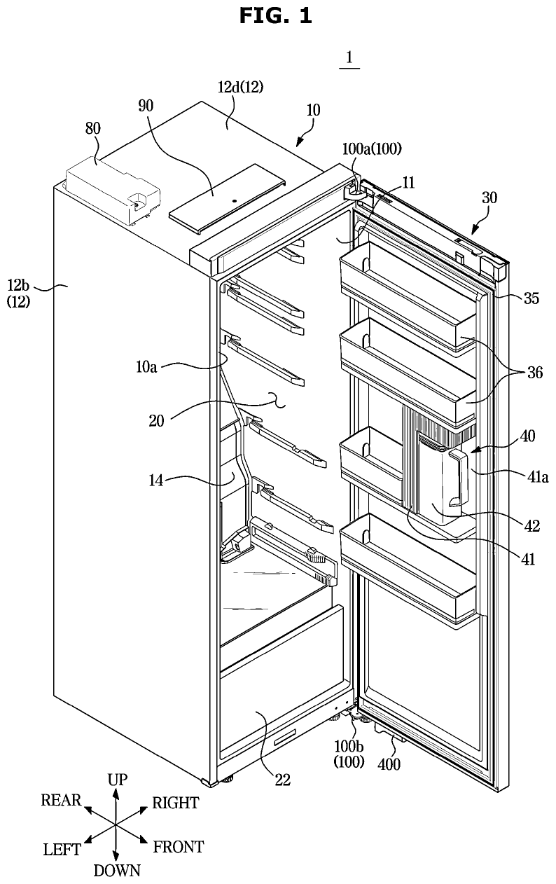

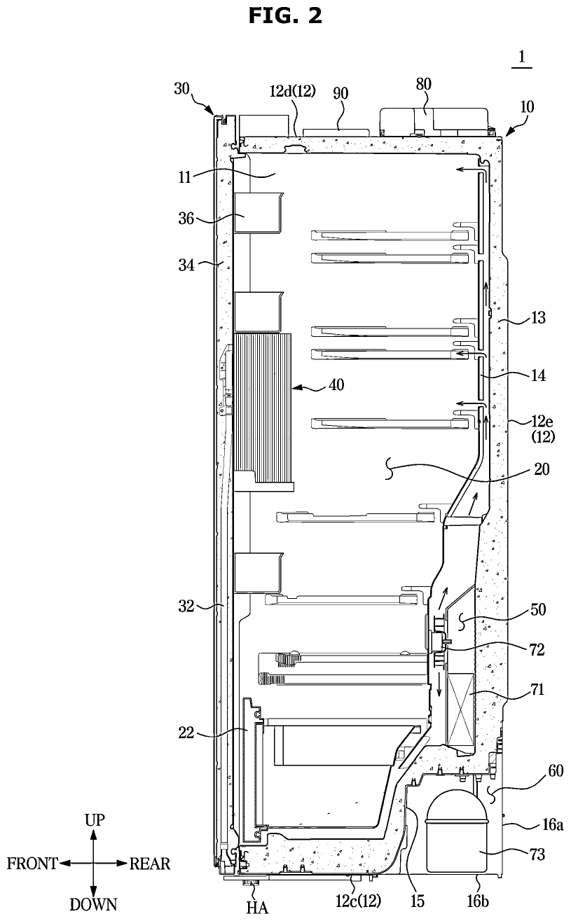

FIG. 1 is a perspective view of a refrigerator according to an embodiment of the present disclosure. FIG. 2 is a schematic side cross-sectional view of a refrigerator according to an embodiment of the present disclosure.

Referring to FIGS. 1 and 2, a refrigerator 1 may include a main body 10, a storage chamber 20 provided inside the main body 10, a door 30 for opening or closing the storage chamber 20, and a cooling system for supplying cool air to the storage chamber 20.

A front side of the main body 10 may open to enable a user to put food in the storage chamber 20 or take food out of the storage chamber 20. That is, the main body 10 may include an opening 10a formed in the front side of the main body 10. The opening 10a of the main body 10 may be opened and closed by the door 30.

The main body 10 may include an inner case 11 forming the storage chamber 20, an outer case 12 forming an appearance of the refrigerator 1, and a body insulation 13 provided between the inner case 11 and the outer case 12.

The outer case 12 may be substantially in a shape of a box of which a front side opens. The outer case 12 may form upper and lower surfaces, left and right surfaces, and a rear surface of the refrigerator 1.

More specifically, the outer case 12 may include a first side wall 12a, a second side wall 12b, a base 12c, an upper wall 12d, and a rear wall 12e.

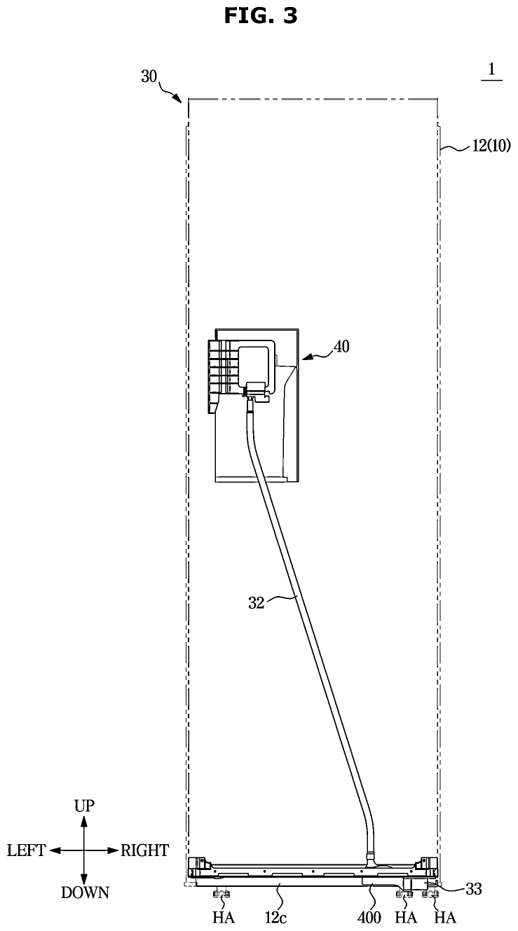

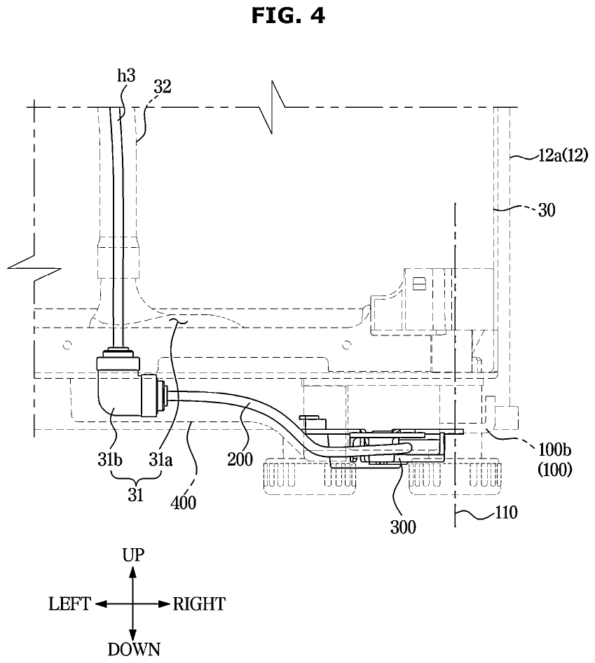

A direction that is perpendicular to an up-down direction and a front-rear direction of the main body 10 is referred to as a lateral direction, and the first side wall 12a (see FIG. 3) and the second side wall 12b may form outer surfaces in lateral direction of the main body 10. For example, the first side wall 12a may form a surface in the lateral direction, which is adjacent to a hinge shaft 110 (see FIG. 4) of the main body 10, and the second side wall 12b may form another surface of the main body 10 in the lateral direction. For example, the first side wall 12a may form a right surface and the second side wall 12b may form a left surface.

The base 12c may form a bottom of the main body 10. The base 12c may support the refrigerator 1. The base 12c may be positioned between the first side wall 12a and the second side wall 12b. The base 12c may be connected to the first side wall 12a and the second side wall 12b.

The upper wall 12d may form an upper surface of the main body 10. The upper wall 12d may be positioned between the first side wall 12a and the second side wall 12b. The upper wall 12d may be connected to the first side wall 12a and the second side wall 12b.

The rear wall 12e may form a rear surface of the main body 10. The rear wall 12e may be positioned between the first side wall 12a and the second side wall 12b. The rear wall 12e may be connected to the first side wall 12a and the second side wall 12b.

At least some of the first side wall 12a, the second side wall 12b, the base 12c, the upper wall 12d, and the rear wall 12e of the outer case 12 may be integrated into one body. For example, the first side wall 12a, the second side wall 12b, and the upper wall 12d may be integrated into one body.

The outer case 12 may include a metal material. For example, the outer case 12 may be manufactured by processing a steel plate material, although not limited thereto.

However, the outer case 12 may be configured in various ways.

A front side of the inner case 11 may open. The inner case 11 may form the storage chamber 20 therein and may be provided inside the outer case 12. An inner wall of the inner case 11 may form an inner wall of the storage chamber 20.

The inner case 11 may include a plastic material. For example, the inner case 11 may be manufactured by a vacuum forming process. For example, the inner case 11 may be manufactured by an injection molding process.

The body insulation 13 may be provided to insulate the outer case 12 and the inner case 11 from each other. The body insulation 13 may be formed between the inner case 11 and the outer case 12 to connect the inner case 11 and the outer case 12 to each other. The body insulation 13 may prevent heat exchange between inside of the storage chamber 20 and outside of the main body 10, thereby improving cooling efficiency inside the storage chamber 20.

The body insulation 13 may be a urethane foam insulation, an expanded polystyrene (EPS) insulation, a vacuum insulation panel, etc., although not limited thereto. However, the body insulation 13 may include various materials.

The storage chamber 20 may be formed inside the main body 10. For example, the storage chamber 20 may include a refrigerating chamber that is maintained at about 0° C. to 5° C. to keep food refrigerated. For example, the storage chamber 20 may include a freezing chamber that is maintained at about 0° C. to 30° C. below zero to keep food frozen.

Inside the storage chamber 20, a shelf on which food is put, and a storage container 22 which is inserted into or withdrawn from the inner case 11 and stores food may be provided.

The refrigerator 1 may include a cooling system for generating cool air by using a cooling cycle and supplying the generated cool air to the storage chamber 20.

The cooling system may generate cool air by using evaporative latent heat of a refrigerant in a cooling cycle. The cooling system may include a compressor 73, a condenser, an expansion valve, an evaporator 71, and a blower fan 72.

The main body 10 may be provided with a cooling room 50 and a machine room 60 where the cooling system is placed. For example, the cooling room 50 may be provided with components such as the evaporator 71 that generates cool air and the blower fan 72 that causes the cool air generated by the evaporator 71 to move. The machine room 60 may be provided with components such as the compressor 73 and the condenser.

The cooling room 50 may be positioned in a rear side of the storage chamber 20. The machine room 60 may be positioned in the rear side of the storage chamber 20.

The components of the refrigerator 1, constituting the cooling system, may have a relatively considerable weight. Accordingly, the cooling room 50 and the machine room 60 may be provided in a lower portion of the main body 10, although not limited thereto. However, the cooling room 50 and the machine room 60 may be arranged in various ways, and the components, constituting the cooling system, may be arranged in various ways to correspond to the positions of the cooling room 50 and the machine room 60.

Because cool air is generated by the evaporator 71 in the cooling room 50, the cooling room 50 may be maintained at a relatively low temperature state. In contrast, because heat is generated by the compressor 73, the condenser, etc. in the machine room 60, the machine room 70 may be maintained at a relatively high temperature state. Accordingly, the cooling room 50 and the machine room 60 may be formed in separate spaces and may be insulated from each other. For example, the main body insulation 13 may be foamed between the cooling room 50 and the machine room 60.

As shown in FIG. 2, the evaporator 71 provided in the cooling room 50 may evaporate a refrigerant to generate cool air, and the cool air generated by the evaporator 71 may move by the blower fan 72. The cool air moved by the blower fan 72 may move from the cooling room 50 to the storage chamber 20. The cooling room 50 may communicate with the storage chamber 20.

For example, cool air generated by the evaporator 71 may move upward from the cooling room 50 by the blower fan 72. The cool air moved by the blower fan 72 may move toward an upper portion of the main body 10 along a cool air supply duct 14. The cool air may be discharged forward from the cool air supply duct 14 and finally flow into the storage chamber 20. Alternatively, for example, cool air generated by the evaporator 71 may move to the lower portion of the main body 10 by the blower fan 72 and then flow into the storage chamber 20.

In other words, as shown in FIG. 2, the refrigerator 1 according to an embodiment of the present disclosure may be an indirect cooling refrigerator. For convenience of explanation, the following description will be given under an assumption that the refrigerator 1 according to an embodiment of the present disclosure is an indirect cooling refrigerator. However, a concept of the present disclosure is not limited thereto and may also be applied to a direct cooling refrigerator.

The evaporator 71, the blower fan 72, etc. placed in the cooling room 50 may be referred to as a cool air supply device in that the evaporator 71, the blower fan 72, etc. generate cool air and supply the cool air to the storage chamber 20.

The main body 10 may include the cool air supply duct 14. The cool air supply duct 14 may form a cool air path through which cool air generated by the cool air supply device moves from the cooling room 50 to the storage chamber 20. The storage chamber 20 may communicate with the cool air supply duct 14.

The cool air supply duct 14 may be formed inside the inner case 11. The cool air supply duct 14 may be formed in a rear side of the inner case 11. More specifically, the cool air supply duct 14 may be provided in the rear side of the storage chamber 20.

The main body 10 may include a machine room inner wall 15 forming an inner wall of the machine room 60. The machine room inner wall 15 may form a front-side inner surface and an upper-side inner surface of the machine room 60. The front-side inner surface and the upper-side inner surface of the machine room 60 formed by the machine room inner wall 15 may be connected to each other.

The machine room inner wall 15 may be integrated into the base 12c. The machine room inner wall 15 may extend by being bent from a rear portion of the base 12c.

The main body 10 may include a machine room rear cover 16a covering a rear side of the machine room 60. The machine room rear cover 16a may be connected to the rear portion of the base 12c. The machine room rear cover 16a may form a rear surface of the main body 10 together with the rear wall 12e of the outer case 12.

The machine room rear cover 16a may be detachably mounted on the outer surface 12.

The main body 10 may include a machine room base 16b that covers a lower portion of the machine room 60. The components placed in the machine room 60, such as the compressor 73 and the condenser, may be rested on the machine room base 16b.

The machine room base 16b may form the bottom of the main body 10 together with the base 12c of the outer case 12. The machine room base 16b may be connected to the rear portion of the base 12c. The machine room base 16b may extend parallel to the base 12c.

The machine room base 16b may be detachably installed in the outer case 12.

The door 30 may open or close the storage chamber 20. The door 30 may be rotatable about the hinge shaft 110 (see FIG. 4) with respect to the main body 10. More specifically, the door 30 may be rotatably coupled to the main body 10 by a hinge assembly 100 connected to the door 30 and the main body 10. The door 30 may be rotatably coupled to the outer case 12.

An outer surface of the door 30 may form a part of the appearance of the refrigerator 1. While the door 30 is in a closed position, the outer surface of the door 30 may form a front surface of the door 30.

While the door 30 is in the closed position, an inner surface of the door 30 may form a rear surface of the door 30. While the door 30 is in the closed position, the inner surface of the door 30 may face inside of the main body 10. While the door 30 is in the closed position, the inner surface of the door 30 may cover the front side of the storage chamber 20.

A foam space may be formed between the outer surface of the door 30 and the inner surface of the door 30, and a door insulation 34 may be formed. The door insulation 34 may prevent heat exchange between the outer surface and the inner surface of the door 30. The door insulation 34 may improve the insulation performance between the inside of the storage chamber 20 and outside of the door 30.

The door insulation 34 may be a urethane foam insulation, an EPS insulation, a vacuum insulation panel, etc., although not limited thereto. However, the door insulation 34 may include various materials.

For example, the door insulation 34 may be composed of the same insulation material as the body insulation 13. Alternatively, for example, the door insulation 34 may be composed of a different insulation material from the body insulation 13.

A door gasket 35 may be provided on the inner surface of the door 30 to seal a gap between the door 30 and the main body 10 and prevent cool air of the storage chamber 20 from leaking out. The door gasket 35 may be provided along edges of the inner surface of the door 30. While the door 30 is in a closed state, the door gasket 35 may be arranged parallel to the opening 10a of the main body 10. The door gasket 35 may include an elastic material such as rubber.

A door shelf 36 for storing food may be provided on the inner surface of the door 30.

Details about components of the door 30 will be described below.

The refrigerator 1 may include the hinge assembly 100 connecting a main body 10 and the door 30. The hinge assembly 100 may support the door 30 such that the door 30 is rotatable with respect to the main body 10. The door 30 may be rotatable about the hinge shaft 110 (see FIG. 4, etc.).

The hinge assembly 100 may include an upper hinge assembly 100a and a lower hinge assembly 100b. The upper hinge assembly 100a may be positioned above the lower hinge assembly 100b. The upper hinge assembly 100a may be connected to the upper portion of the main body 10 and an upper portion of the door 30. The lower hinge assembly 100b may be connected to the lower portion of the main body 10 and a lower portion of the door 30.

The upper hinge assembly 100a and the lower hinge assembly 100b may be aligned in the up-down direction. The door 30 may rotate about a rotation shaft extending in the up-down direction with respect to the main body 10 by the upper hinge assembly 100a and the lower hinge assembly 100b. In other words, the hinge shaft 110 may extend in the up-down direction of the refrigerator 1.

The upper hinge assembly 100a and the lower hinge assembly 100b may have corresponding configurations. Alternatively, the upper hinge assembly 100a and the lower hinge assembly 100b may have different configurations.

Details about a configuration of the hinge assembly 100 will be described below.

The refrigerator 1 may include at least a height-adjusting member HA provided on a bottom of the refrigerator 1 and configured to adjust a height of the refrigerator 1 relative to a floor. For example, the height-adjusting member HA may include a screw structure having threads to adjust a height of the refrigerator 1 relative to a floor.

The height-adjusting member HA may support the bottom of the refrigerator 1. For example, the height-adjusting member HA may be positioned at various locations, such as the base 12c of the main body 10 and a lower surface of the door 30.

For example, the at least a height-adjusting member HA may be positioned at the hinge shaft 110 as shown in FIG. 3, etc.

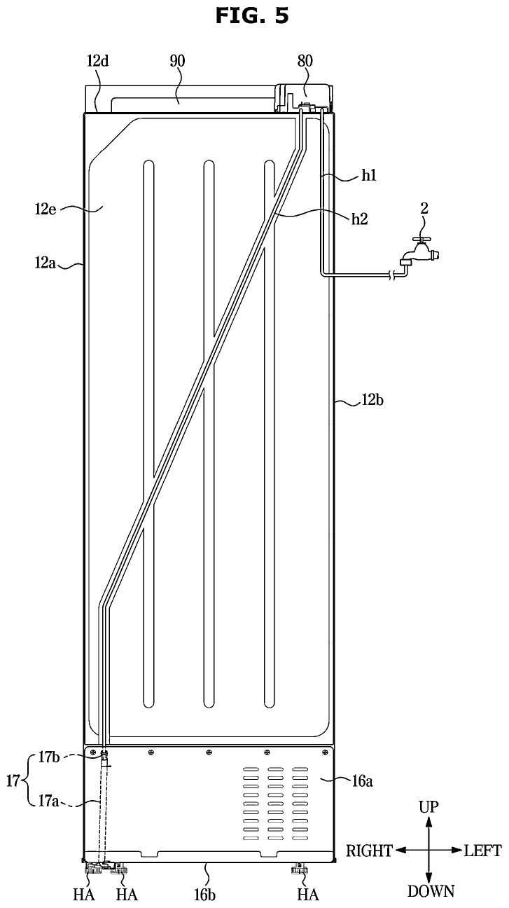

The refrigerator 1 may include a valve device 80 that supplies water received from an external water source 2 (see FIG. 5) to a water supply device 41. The valve device 80 may be configured to open or close a water supply path toward the water supply device 41 from the external water source 2.

For example, the valve device 80 may be mounted on the upper wall 12d of the outer case 12. However, a mounting location of the valve device 80 is not limited thereto.

Details about a configuration and operation of the valve device 80 will be described below.

The refrigerator 1 may include a control device configured to control operations of the refrigerator 1. The control device of the refrigerator 1 may be configured with various electrical components such as at least a printed circuit board assembly (PBA).

For example, the control device of the refrigerator 1 may be configured to control operations of components of the cooling system, such as the evaporator 71, the blower fan 72, the compressor 73, and the condenser. For example, the control device of the refrigerator 1 may be configured to control the valve device 80 to open or close the water supply path toward the water supply device 41 from the external water source 2. For example, the control device of the refrigerator 1 may be configured to control operations of the water supply device 41. Alternatively, for example, the refrigerator 1 may include a display device, and in this case, the control device of the refrigerator 1 may be configured to control operations of the display device.

The refrigerator 1 may include an electrical box 90 that accommodates at least a part of various electrical components constituting the control device. For example, the electrical box 90 may be mounted on the upper wall 12d of the outer case 12. However, a mounting location of the electrical box 90 is not limited thereto.

The refrigerator 1 may include a water supply assembly 40 for providing water to a user. The water supply assembly 40 may receive water from the external water source 2 (see FIG. 5). The water supply assembly 40 may include the water supply device 41 and a water tank 42.

The water supply device 41 may supply water supplied from the external water source 2 (see FIG. 5) to the water tank 42. The water tank 42 may store the water supplied from the water supply device 41.

The water supply device 41 may include a water tank installing space 41a in which the water tank 42 is installed. The water tank 42 may be detachably installed in the water tank installing space 41a.

The water supply device 41 may include an outlet formed to supply water to the water tank 42 installed in the water tank installing space 41a. The water tank 42 may include an inlet which water discharged from the outlet of the water supply device 41 enters. For example, the outlet of the water supply device 41 may discharge water supplied from the external water source 2 downward. For example, the inlet of the water tank 42 may be formed in an upper portion of the water tank 42 and penetrate the water tank 42 in the up-down direction. For example, according to installing of the water tank 42 in the water tank installing space 41a, the outlet of the water supply device 41 may face the inlet of the water tank 42 in the up-down direction.

The refrigerator 1 may include a water tank sensor that detects whether the water tank 42 has been installed in the water tank installing space 41a. The water tank sensor may be positioned, for example, on the inner surface of the door 30 or in the water supply device 41. The control device of the refrigerator 1 may identify whether the water tank 42 has been installed in the water tank installing space 41a based on an output value from the water tank sensor. The control device of the refrigerator 1 may be configured to control the valve device 80 and the water supply device 41 such that water is supplied to the water tank 42 only in the case in which the water tank 42 has been installed in the water tank installing space 41a. As an example, the water tank sensor may be configured as a hall sensor that detects a magnet provided in the water tank 42.

After the water tank 42 is installed in the water tank installing space 41a, the water supply device 41 may automatically supply water to the water tank 42 such that a preset amount of water is filled inside the water tank 42. The preset amount may be approximately a full water level of the water tank 42.

For example, the water supply device 41 may include a water level sensor that detects a water level inside the water tank 42 according to installing of the water tank 42 in the water tank installing space 41a. The water level sensor may output an electrical signal corresponding to the water level inside the water tank 42. The control device of the refrigerator 1 may receive the electrical signal output from the water level sensor and identify an amount of water stored inside the water tank 42 based on the electrical signal. The control device of the refrigerator 1 may be configured to control the valve device 80 and the water supply device 41 to cut off water supply to the water tank 42 when the amount of water stored inside the water tank 42 is identified to be more than or equal to the preset amount of water. The control device of the refrigerator 1 may be configured to control the valve device 80 and the water supply device 41 to supply water to the water tank 42 when the amount of water stored inside the water tank 42 is identified to be less than the preset amount. For example, the water level sensor may be configured as a capacitive sensor that detects capacitance changing according to a water level inside the water tank 42.

The water supply device 41 may be mounted on the door 30. For example, the water supply device 41 may be mounted on the inner surface of the door 30. While the door 30 is closed, the water supply device 41 may be located inside the storage chamber 20, and the water tank 42 installed in the water tank installing space 41a may be located inside the storage chamber 20. While the door 30 is closed, the water tank 42 installed in the water tank installing space 41a may be cooled by cool air of the storage chamber 20, and accordingly, a user may receive cool water from the water tank 42.

The water supply device 41 may receive water from the external water source 2 by water pressure of the external water source 2 and control of the valve device 80, and may supply the water to the water tank 42.

Details about a configuration of the water supply device 41 for receiving water from the external water source 2 will be described below.

However, the configuration of the water supply device 41 described above is only an example for describing a water supply device of the refrigerator according to an aspect of the present disclosure, and the aspect of the present disclosure is not limited thereto. The refrigerator 1 according to an embodiment of the present disclosure may include a water supply device installed on the door 30 and configured to supply water while a lever is pressed. Alternatively, the refrigerator 1 according to an embodiment of the present disclosure may include a separate water supply device configured to supply water while a lever is pressed, in addition to the water supply device 41 that automatically supplies a preset amount of water to the water tank 42 after the water tank 42 is installed as described above.

The configuration of the refrigerator 1 described above with reference to FIGS. 1 and 2 is only an example for describing a refrigerator according to an aspect of the present disclosure, and the aspect of the present disclosure is not limited thereto. The refrigerator according to an aspect of the present disclosure may include various configurations for performing a function of supplying cool air to a storage chamber for storing food.

So far, for convenience of description, the refrigerator 1 including the main body 10 in which the single storage chamber 20 is formed and the single door 30 for opening or closing the storage chamber 20 has been described as an example of the present disclosure. However, the present disclosure is not limited thereto, and a configuration of the present disclosure may be applied to various types of refrigerators. The refrigerator according to an embodiment of the present disclosure may be a Side by Side (SBS) type in which a refrigerating chamber and a freezing chamber are arranged left and right. Alternatively, the refrigerator according to an embodiment of the present disclosure may be a Bottom Mounted Freezer (BMF) type in which a refrigerating chamber is formed on the upper side and a freezing chamber is formed on the lower side. The refrigerator according to an embodiment of the present disclosure may be a Top Mounted Freezer (TMF) type in which a freezing chamber is formed on the upper side and a refrigerating chamber is formed on the lower side.

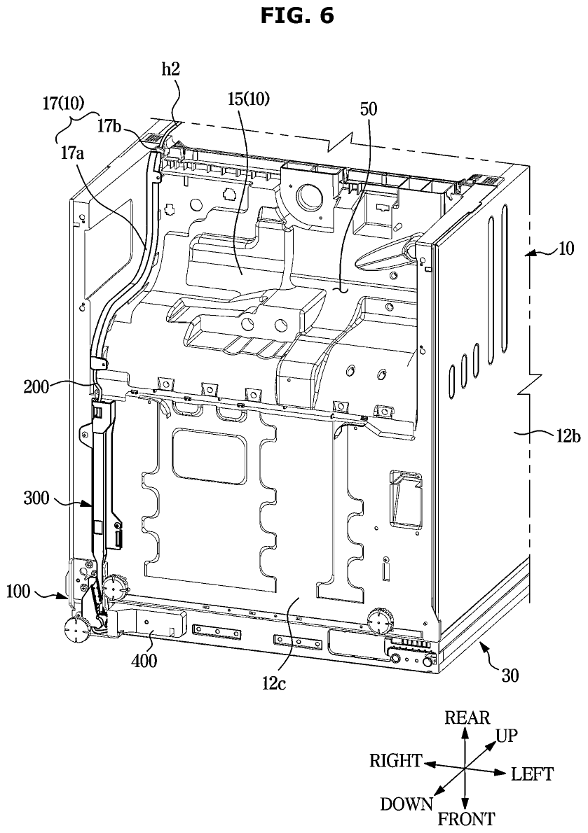

FIG. 3 is a front view of a refrigerator according to an embodiment of the present disclosure. FIG. 4 is an enlarged view of some components of a refrigerator according to an embodiment of the present disclosure. FIG. 5 is an exploded rear view of some components of a refrigerator according to an embodiment of the present disclosure. FIG. 6 is an exploded bottom view of some components of a refrigerator according to an embodiment of the present disclosure.

Referring to FIGS. 3 to 6, the refrigerator 1 may include a supply member including at least one of a wire or a pipe. The supply member may be connected to the main body 10 and the door 30.

The supply member may include a wire electrically connected to an external power source, components of the refrigerator 1 provided in the main body 10, components of the refrigerator 1 provided in the door 30, etc.

For example, components electrically connected to the supply member, among components of the refrigerator 1 provided in the main body 10, may include the control device of the refrigerator 1, a temperature sensor that detects temperature inside the storage chamber 20, etc.

For example, components electrically connected to the supply member, among components of the refrigerator 1 provided in the door 30, may include the water supply device 41, the display device, etc.

For example, the supply member may be electrically connected to the external power source and may supply power to the water supply device 41, the display device, etc., provided in the door 30. The refrigerator 1 may receive power from the external power source through a power supply provided in the main body 10, and because the supply member is connected to the door 30 and the main body 10, power supplied from the external power source may be transferred from the main body 10 to the door 30.

For example, the supply member may be electrically connected to the control device of the refrigerator 1 configured by electrical components accommodated in the electrical box 90. The supply member may transmit an electrical signal for driving control from the control device of the refrigerator 1 to the display device, the water supply device 41, etc. provided in the door 30. The supply member may transfer an electrical signal output from various sensors (for example, a water level sensor) of the water supply device 41, an input device that receives a user input, etc., to the control device of the refrigerator 1. Various components that constitute the control device of the refrigerator 1, such as the electrical components accommodated in the electrical box 90, may be positioned in the main body 10, and because the supply member is connected to the door 30 and the main body 10, the components of the main body 10 and the components of the door 30 may exchange electrical signals with each other.

The supply member may include a pipe 200 that supplies water received from the external water source 2 to the water supply device 41. Hereinafter, in the following description with reference to FIGS. 3 to 14, it is assumed that the supply member is a pipe 200 for supplying water. In addition, for convenience of description, the pipe 200 will be referred to as a supply member 200 below.

The supply member 200 may be connected to the main body 10 and the door 30. The supply member 200 may allow water supplied from the external water source 2 to flow to the door 30 and then be supplied to the water supply device 41 provided in the door 30.

More specifically, the valve device 80 positioned in the main body 10 may be connected to the external water source 2 by an external connection hose h1. The external connection hose h1 may be provided between the external water source 2 and the valve device 80, and allow water supplied from the external water source 2 to flow to the valve device 80.

The valve device 80 may be connected to a body supply portion 17 of the main body 10, which will be described below, by a valve connection hose h2. The valve connection hose h2 may be provided between the valve device 80 and the body supply portion 17, and may allow water supplied from the valve device 80 to flow to the body supply portion 17.

The valve device 80 may be connected to the external connection hose h1 and the valve connection hose h2. The valve device 80 may open or close a flow path between the external connection hose h1 and the valve connection hose h2. For example, the valve device 80 may open or close the flow path between the external connection hose h1 and the valve connection hose h2 based on control by the control device of the refrigerator 1. While the valve device 80 opens the flow path between the external connection hose h1 and the valve connection hose h2, water may be supplied to the water supply device 41 by water pressure from the external water source 2. While the valve device 80 closes the flow path between the external connection hose h1 and the valve connection hose h2, water supply to the water supply device 41 may be cut off.

The valve connection hose h2 may extend to a rear portion of the refrigerator 1 from the valve device 80 and be connected to the body supply portion 17.

The main body 10 may include the body supply portion 17 to which the supply member 200 is connected. The body supply portion 17 may be connected to the valve connection hose h2. The main body supply portion 17 may connect the supply member 200 to the valve connection hose h2.

The body supply portion 17 may include a body extension pipe 17a and a body connector 17b provided at an end of the body extension pipe 17a.

The body extension pipe 17a may extend from the rear wall 12e of the outer case 12 toward the base 12c. The body extension pipe 17a may extend along the machine room inner wall 15 and extend from the rear wall 12e of the outer case 12 toward the machine room base 16b. The body extension pipe 17a may extend in a direction corresponding to a shape of the machine room inner wall 15.

A portion of the supply member 200 may be accommodated in the body extension pipe 17a. The supply member 200 may penetrate the machine room base 16b and a portion of the supply member 200 may be accommodated in the body extension pipe 17a.

Another end of the body extension pipe 17a, which is opposite to the end of the body extension pipe 17a at which the body connector 17b is provided, may be penetrated by the supply member 200.

The body connector 17b may be connected to the valve connection hose h2 and the supply member 200. The body connector 17b may connect the valve connection hose h2 to the supply member 200 such that the valve connection hose h2 communicates with the supply member 200.

For example, the body connector 17b may be covered by the machine room rear cover 16a inside the machine room 60. In this case, the valve connection hose h2 may penetrate the machine room rear cover 16a. Alternatively, for example, at least a portion of the body connector 17b may be positioned outside the machine room 60.

By this configuration, the supply member 200 may be connected to the valve connection hose h2 through the body supply portion 17, and while the valve device 80 opens the flow path, the supply member 200 may receive water from the valve connection hose h2.

The supply member 200 may be connected to the water supply device 41 by the door connection hose h3. The door connection hose h3 may be provided between the supply member 200 and the water supply device 41. The door connection hose h3 may allow water supplied from the supply member 200 to flow to the water supply device 41.

The door 30 may include a door supply portion 31 to which the supply member 200 is connected. The door supply portion 31 may be connected to the door connection hose h3. The door supply portion 31 may connect the supply member 200 to the door connection hose h3.

The door supply portion 31 may be provided in a side of the door 30. The door supply portion 31 may be provided in a side of the door 30 adjacent to a location at which the supply member 200 is positioned. For example, as shown in FIGS. 3 to 6, the door supply portion 31 may be provided in a lower side of the door 30. For example, in the case in which the supply member 200 is positioned in an upper side of the door 30, the door supply portion 31 may be provided in the upper side of the door 30.

The door supply portion 31 may include a door connector 31b. The door connector 31b may be connected to the door connection hose h3 and the supply member 200. The door connector 31b may connect the door connection hose h3 to the supply member 200 such that the door connection hose h3 communicates with the supply member 200.

The door supply portion 31 may include a door supply groove 31a. At least a portion of the door connector 31b may be positioned inside the door supply groove 31a. The door supply groove 31a may be formed by being concavely depressed in a surface of the door 30. The door supply portion 31 may be formed by being concavely depressed in a surface of the door 30 adjacent to the location at which the supply member 200 is positioned. For example, as shown in FIGS. 3 to 6, the door supply groove 31a may be formed by being concavely depressed in the lower surface of the door 30. For example, in the case in which the supply member 200 is positioned in the upper side of the door 30, the door supply groove 31a may be formed by being concavely depressed in an upper surface of the door 30.

The door 30 may include a door extension pipe 32 extending from the door supply portion 31 toward the water supply device 41. The door extension pipe 32 may be connected to the water supply device 41 and the door supply portion 31. More specifically, the door extension pipe 32 may connect the water supply device 41 to the door supply groove 31a.

At least a portion of the door connection hose h3 may be accommodated inside the door extension pipe 32. The door extension pipe 32 may be penetrated by the door connection hose h3.

The door extension pipe 32 may communicate with the door supply groove 31a. The door extension pipe 32 may communicate with inside of the water supply device 41. The door connection hose h3 may extend along the door extension pipe 32 and be connected to the water supply device 41.

The door extension pipe 32 may be positioned inside the door 30. The door extension pipe 32 may be embedded in the door insulation 34 formed inside the door 30.

By the above-described configuration, the door connection hose h3 may be connected to the supply member 200 through the door supply portion 31, and while the valve device 80 opens the flow path, the water supply device 41 connected to the door connection hose h3 may receive water from the supply member 200.

For example, at least some of the external connection hose h1, the valve connection hose h2, the door connection hose h3, and the supply member 200 may be integrated into one pipe. For example, the external connection hose h1, the valve connection hose h2, the door connection hose h3, and the supply member 200 may be formed as separate pipes and connected to each other.

As described above, the supply member 200 may be connected to the main body 10 and the door 30, and the door 30 may be rotatable about the hinge shaft 110 with respect to the main body 10. At a portion at which the main body 10 is connected to the door 30, a portion of the supply member 200 may change in position according to a rotation of the door 30.

To reduce a range within which the portion of the supply member 200 changes in position at the portion at which the main body 10 is connected to the door 30, as shown in FIGS. 3 to 6, the door supply portion 31 may be positioned adjacent to the hinge shaft 110 in the door 30. In other words, when a direction perpendicular to a direction in which the hinge shaft 110 extends and a direction in which the outer and inner surfaces of the door 30 face each other is referred to as a lateral direction of the door 30, the door supply portion 31 may be located adjacent to a surface of the door 30, which is adjacent to the hinge shaft 110 among both surfaces in lateral direction of the door 30. Accordingly, the supply member 200 may be connected to the door 30 at a location adjacent to the hinge shaft 110, and a range within which a position of the supply member 200 changes while the door 30 is opened or closed may be reduced.

The water supply device 41 may be mounted at a location that is opposite to the surface of the door 30 adjacent to the hinge shaft 110 of the door 30 to improve user accessibility. In other words, the water supply device 41 may be located adjacent to the other surface of the door 30, which is opposite to the hinge shaft 110, among both surfaces in lateral direction of the door 30.

Accordingly, the door extension pipe 32 connecting the door supply portion 31 to the water supply device 41 and the door connection hose h3 accommodated inside the door extension pipe 32 may extend with an angle substantially inclined with respect to horizontal and vertical directions of the door 30, although not limited thereto.

However, components, such as the door supply portion 31, the water supply device 41, etc., may be positioned in various ways, and the door extension pipe 32 and the door connection hose h3 may extend in various directions to correspond to an arrangement of the door supply portion 31 and the water supply device 41.

By the above-described configuration, water supplied from the external water source may pass through components, such as the main body 10, the supply member 200, etc., sequentially, and flow to the door 30, more specifically, to the water supply device 41.

For example, an external filter for filtering water flowing along the external connection hose h1 may be provided between the external water source 2 and the valve device 80. The external filter may be provided outside the refrigerator 1. Alternatively, for example, the refrigerator 1 may be provided with a separate filter for filtering water supplied through the external connection hose h1.

Content described above with reference to FIGS. 3 to 6 relates to only an example of a configuration for allowing water supplied from the external water source 2 to flow to the water supply device 41 by the supply member 200. However, the present disclosure is not limited thereto. In the refrigerator according to an aspect of the present disclosure, the supply member connected to the main body and the door may supply water from the main body to the door by various configurations.

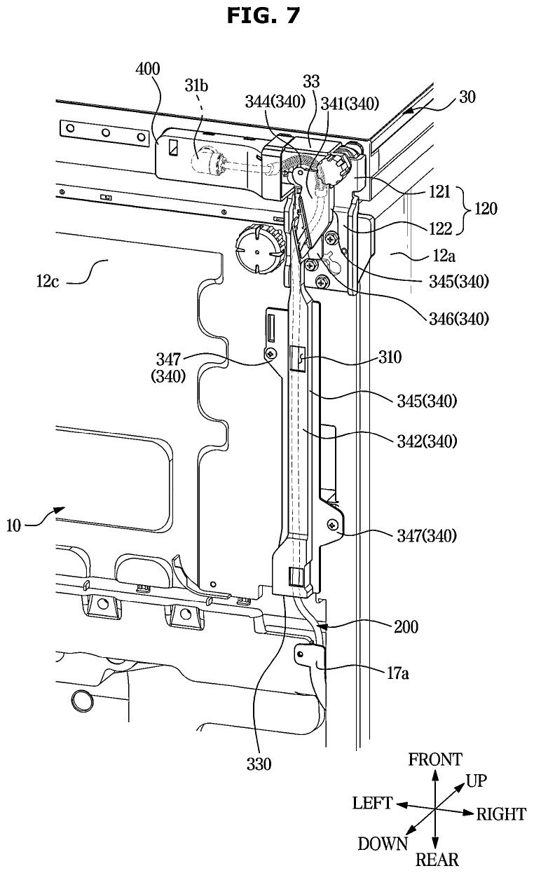

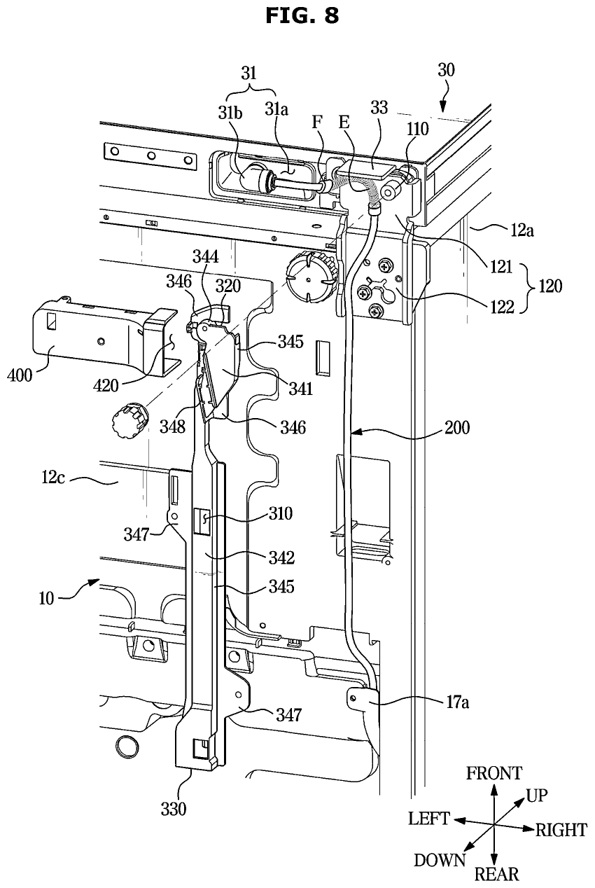

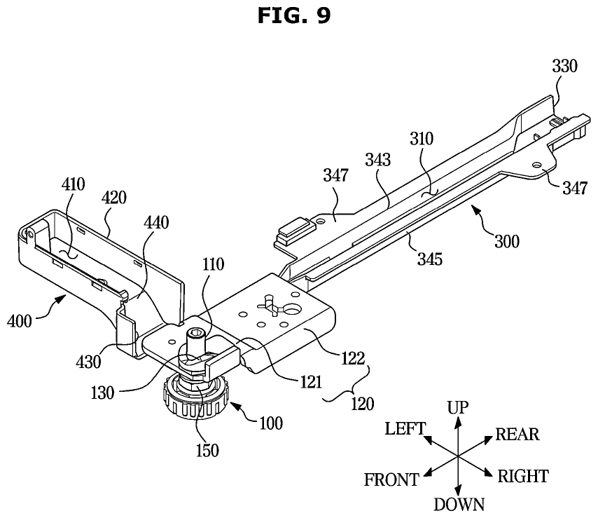

FIG. 7 is a bottom view of a refrigerator according to an embodiment of the present disclosure. FIG. 8 is an exploded view of a supply cover and a door cover member in a refrigerator according to an embodiment of the present disclosure. FIG. 9 shows some components of a refrigerator according to an embodiment of the present disclosure.

In the following description about components of the refrigerator 1 according to an embodiment of the present disclosure with reference to FIGS. 7 to 9, components provided in a lower side of the refrigerator 1 will be mainly described. Components of the refrigerator 1, which will be described below, may be applied correspondingly to components provided in an upper side of the refrigerator 1.

For example, the lower hinge assembly 100b will be described below, and for convenience of description, the lower hinge assembly 100b is referred to as a hinge assembly 100.

Referring to FIGS. 7 to 9, the refrigerator 1 may include the hinge assembly 100. The door 30 may be rotatable with respect to the main body 10 by the hinge assembly 100.

The hinge assembly 100 may include the hinge shaft 110 and a hinge bracket 120.

The door 30 may be rotatable about the hinge shaft 110 with respect to the main body 10. The hinge shaft 110 may function as a rotation axis of the door 30.

For example, the hinge shaft 110 may extend in the up-down direction. The door 30 may be rotatable about the rotation axis extending in the up-down direction.

The hinge shaft 110 may be inserted in the door 30. The hinge shaft 110 may penetrate the hinge bracket 120. Accordingly, the hinge bracket 120 may be connected to the door 30. Also, the door 30 may be supported by the hinge bracket 120 to be rotatable about the hinge shaft 110.

For example, the hinge shaft 110 may be inserted in the door 30 in the up-down direction. For example, the hinge shaft 110 may penetrate the hinge bracket 120 in the up-down direction.

Referring to FIGS. 7 to 9, the hinge shaft 110 may be positioned in a right portion of the refrigerator 1 seen from front, although not limited thereto. The hinge shaft 110 may be located in various positions of the refrigerator 1 such as a left portion of the refrigerator 1.

The hinge shaft 110 may be configured as a member having a substantially cylindrical shape to facilitate a rotation of the door 30.

The hinge bracket 120 may connect the door 30 to the main body 10. The hinge bracket 120 may support the door 30 such that the door 30 is rotatable about the hinge shaft 110 with respect to the main body 10.

The hinge bracket 120 may support the hinge shaft 110. For example, the hinge shaft 110 may be coupled to the hinge bracket 120 by a coupling member 150 of the hinge assembly 100.

The hinge bracket 120 may be penetrated by the hinge shaft 110. More specifically, a hole through which the hinge shaft 110 penetrates the hinge bracket 120 may have a shape and size corresponding to the hinge shaft 110. Accordingly, the hinge shaft 110 may be prevented from moving with respect to the hinge bracket 120 and stably supported.

The hinge bracket 120 may be coupled to the door 30 and the main body 10. The hinge bracket 120 may include a door coupling portion 121 coupled to the door 30, and a body coupling portion 122 coupled to the main body 10.

The door coupling portion 121 may be connected to the door 30 in such a way that the door 30 is rotatable. More specifically, the door coupling portion 121 may be penetrated by the hinge shaft 110, and the door 30 may be rotatably connected to the door coupling portion 121 through the hinge shaft 110. That is, the door 30 may be rotatable about the hinge shaft 110 with respect to the door coupling portion 121.

The door 30 may include a door bracket 33 located at a surface of the door 30 which the hinge shaft 110 penetrates. The door bracket 33 may face the hinge bracket 120. The door bracket 33 may be fixed to a surface of the door 30 to which the hinge bracket 120 is coupled. The door coupling portion 121 may be coupled to the door bracket 33. The door bracket 33 may be penetrated by the hinge shaft 110, and may be rotatable about the hinge shaft 110 with respect to the door coupling portion 121.

The door bracket 33 may cover a portion of the supply member 200. More specifically, the door bracket 33 may cover a bending portion 210 of the supply member 200, which will be described below. While the door 30 is in a closed position, a front part of the bending portion 210 may be covered by the door bracket 33.

The hinge assembly 100 may include a cam member 130 that is in contact with the door bracket 33. The cam member 130 may be positioned between the door bracket 33 and the door coupling portion 121.

The cam member 130 may be penetrated by the hinge shaft 110. The door bracket 33 may be rotatable about the hinge shaft 110 with respect to the cam member 130.

The cam member 130 may be fixed to the hinge bracket 120. More specifically, the cam member 130 may be fixed to the door coupling portion 121. For example, the cam member 130 may be coupled to the door coupling portion 121 by a screw.

The cam member 130 may include a curved shape. At a side of the door bracket 33 toward the cam member 130, a cam-shaped structure corresponding to the curved shape of the cam member 130 may be formed. The curved shape of the cam member 130 may be in contact with the curved shaped structure formed at the side of the door bracket 33. The curved shaped structure formed at the side of the door bracket 33 may be penetrated by the hinge shaft 110 and fixed to the door bracket 33 to be rotatable about the hinge shaft 110 together with the door bracket 33. Accordingly, the door 30 may be more easily rotatable with respect to the hinge bracket 120.

The hinge assembly 100 may include the coupling member 150 for coupling components of the hinge assembly 100, such as the hinge shaft 110, the hinge bracket 120, the cam member 130, etc., to the door bracket 33.

The coupling member 150 may be located on another surface of the hinge bracket 120, which is opposite to the surface of the hinge bracket 120 facing the door 30. In other words, the coupling member 150 may be located on another surface of the door coupling portion 121, which is opposite to the door bracket 33, although not limited thereto.

However, the door coupling portion 121 may be coupled to the door 30 in various ways.

The body coupling portion 122 may be coupled to the outer case 12 of the main body 10. More specifically, the body coupling portion 122 may be coupled to any one of the upper wall 12d or the base 12c of the main body 10. For example, the body coupling portion 122 may be coupled to the base 12c as shown in FIGS. 7 and 8.

The hinge bracket 120 may be fixed to the main body 10. That is, the body coupling portion 122 may be fixed to the main body 10. For example, the body coupling portion 122 may be fixed to the main body 10 by fastening with a screw, although not limited thereto. However, the body coupling portion 122 may be fixed to the main body 10 by various methods.

The door coupling portion 121 may be formed with a substantially flat plate shape. At a part of edges of the door coupling portion 121, a shape bent from the plate shape may be formed to support another component, etc. of the hinge assembly 100. The body coupling portion 122 may be formed with a substantially flat plate shape. At a part of edges of the body coupling portion 122, a shape bent from the plate shape may be formed to support a supply cover 300, etc. The supply cover 300 which will be described below may be coupled to the flat plate shapes of the door coupling portion 121 and the body coupling portion 122. At least a portion of the supply member 200 may be positioned between the flat plate shapes of the door coupling portion 121 and the body coupling portion 122 and the supply cover 300, although not limited thereto. However, the door coupling portion 121 and the body coupling portion 122 may be formed with various shapes.

At a location at which the door coupling portion 121 is connected to the body coupling portion 122, a step may exist. The step between the door coupling portion 121 and the body coupling portion 122 may depend on relative positions, etc. of the door 30 and the main body 10.

The door coupling portion 121 and the body coupling portion 122 may be fixed to and connected to each other. The door coupling portion 121 and the body coupling portion 122 may be maintained at locations fixed with respect to each other. Accordingly, the door coupling portion 121 and the body coupling portion 122 may be maintained at fixed positions with respect to the main body 10 regardless of opening or closing of the door 30. In other words, the hinge bracket 120 may be maintained at a fixed location with respect to the main body 10 regardless of opening or closing of the door 30. For example, the door coupling portion 121 and the body coupling portion 122 may be integrated into one body, and the body coupling portion 122 may be fixed to the main body 10.

The door coupling portion 121 may be positioned in front of the body coupling portion 122. The door coupling portion 121 may extend forward from the body coupling portion 122. The hinge bracket 120 may extend in a front-rear direction of the refrigerator 1.

The above-described configuration of the hinge assembly 100 is only an example of a hinge assembly that connects a door to a main body such that the door is rotatable with respect to the main body in a refrigerator according to a concept of the present disclosure. However, the concept of the present disclosure is not limited thereto.

At least a portion of the supply member 200 may be located at a side of the hinge bracket 120. At least a portion of the supply member 200 may be positioned along the hinge bracket 120. More specifically, at least a portion of the supply member 200 may be located at another side of the hinge bracket 120, which is opposite to a side of the hinge bracket 120 being in contact with the main body 10 and the door 30. For example, in the case in which the hinge bracket 120 is located on the lower portion of the refrigerator 1, at least a portion of the supply member 200 may be located below the hinge bracket 120. For example, in the case in which the hinge bracket 120 is located on the upper portion of the refrigerator 1, at least a portion of the supply member 200 may be located above the hinge bracket 120.

When a direction which is perpendicular to the extension direction of the hinge shaft 110 and the front-rear direction of the main body 10 is a lateral direction of the refrigerator 1, the main body 10 may include the first side wall 12a and the second side wall 12b forming both surfaces in lateral direction of the main body 10. For example, in the case in which the hinge shaft 110 is in the up-down direction, as shown in FIGS. 7 to 9, the lateral direction of the refrigerator 1 may be a left-right direction of the refrigerator 1. For example, unlike FIGS. 7 to 9, in the case in which the hinge shaft 110 extends in the left-right direction, the lateral direction of the refrigerator 1 may be an up-down direction of the refrigerator 1.

However, the following description will be, for convenience of description, given based on an embodiment in which the hinge shaft 110 extends in the up-down direction of the main body 10 and the lateral direction of the refrigerator 1 is the left-right direction of the refrigerator 1.

The first side wall 12a may form a surface in lateral direction of the main body 10 adjacent to the hinge shaft 110. The second side wall 12b may form another surface in lateral direction of the main body 10, which is opposite to the first side wall 12a. The first side wall 12a may be opposite to the second side wall 12b. For example, the first side wall 12a and the second side wall 12b may form left and right surfaces of the refrigerator 1. For example, in the case in which the hinge shaft 110 is in a right side of the refrigerator 1, the first side wall 12a may form a right surface of the main body 10, and the second side wall 12b may form a left surface of the main body 10. For example, in the case in which the hinge shaft 110 is located at a left side of the refrigerator 1, the first side wall 12a may form the left surface of the main body 10 and the second side wall 12b may form the right surface of the main body 10.

The supply member 200 may be connected to the main body 10 and the door 30, and at least a portion of the supply member 200 may have a relative position with respect to the main body 10, the hinge bracket 120, etc. depending on opening or closing of the door 30.

To reduce an influence on the supply member 200 by opening or closing of the door 30, the door supply portion 31 to which the supply member 200 is connected may be provided adjacent to the hinge shaft 110. Correspondingly, a portion of the supply member 200 may be positioned adjacent to the hinge shaft 110. At least a portion of the supply member 200 may be positioned adjacent to the first side wall 12a.

The supply member 200 may include the bending portion 210 that is bendable according to opening or closing of the door 30. More specifically, while the door 30 rotates from an open position to a closed position, a bending angle of the bending portion 210 may increase.

The refrigerator 1 may include the supply cover 300 that covers the supply member 200. The supply cover 300 may cover at least a portion of the supply member 200.

For example, as shown in FIGS. 7 to 9, the supply cover 300 may cover the at least a portion of the supply member 200 from below. For example, unlike FIGS. 7 to 9, the supply cover 300 may cover the at least a portion of the supply member 200 from above.

The supply cover 300 may cover a side of the hinge bracket 120. For example, as shown in FIGS. 7 to 9, the supply cover 300 may cover a lower side of the hinge bracket 120. For example, as shown in FIGS. 7 to 9, the supply cover 300 may cover an upper side of the hinge bracket 120. That is, the supply cover 300 may cover both the hinge bracket 120 and at least a portion of the supply member 200 positioned along the hinge bracket 120.

The supply cover 300 may cover one sides of the door coupling portion 121 and the body coupling portion 122 of the hinge bracket 120. In this case, the supply cover 300 may not necessarily cover an entire of the door coupling portion 121 and an entire of the body coupling portion 122, and may cover a part of the door coupling portion 121 and a part of the body coupling portion 122, as shown in FIG. 7.

The supply cover 300 may cover one side of a portion of the main body 10. For example, as shown in FIGS. 7 to 9, the supply cover 300 may cover a lower side of the base 12c. For example, unlike FIGS. 7 to 9, the supply cover 300 may cover an upper side of the upper wall 12d.

The supply cover 300 may be fixed to the hinge bracket 120. For example, the supply cover 300 may be fixed to the hinge bracket 120 by fastening with a screw.

The supply cover 300 may be fixed to the main body 10. For example, the supply cover 300 may be fixed to the main body 10 (the base 12c in FIG. 7) by fastening with a screw.

The supply cover 300 may be penetrated by the supply member 200. The supply cover 300 may include a first through hole 320 and a second through hole 330 which the supply member 200 penetrates. The supply member 200 may penetrate the first through hole 320 and the second through hole 330.

The first through hole 320 may be formed in an end of an accommodating groove 310 which will be described below, toward the door 30. The second through hole 330 may be formed in another end of the accommodating groove 310, which is opposite to the first through hole 320. The first through hole 320 may be located in the front direction of the second through hole 330.

The first through hole 320 may be penetrated by the bending portion 210. The second through hole 330 may be penetrated by a portion of the supply member 200 located behind the bending portion 210.

The first through hole 320 may have a shape that opens in the front-rear direction of the main body 10.

The first through hole 320 may be located at a side of the door coupling portion 121. For example, as shown in FIGS. 7 to 9, the first through hole 320 may be located below the door coupling portion 121. For example, unlike FIGS. 7 to 9, the first through hole 320 may be located above the door coupling portion 121.

The second through hole 330 may be formed with a shape that opens in the front-rear direction of the main body 10.

The second through hole 330 may face the body extension pipe 17a of the body supply portion 17. The supply member 200 may penetrate the second through hole 330 and the body extension pipe 17a.

The second through hole 330 may be located in a side of the main body 10. For example, as shown in FIGS. 7 to 9, the second through hole 330 may be located below the base 12c. For example, unlike FIGS. 7 to 9, the second through hole 330 may be located above the upper wall 12d.

The supply cover 300 may extend in the front-rear direction of the refrigerator 1.

The supply cover 300 may cover the hinge bracket 120, and a portion of the main body 10 positioned behind the hinge bracket 120. Correspondingly, the accommodating groove 310 which will be described below may extend in the front-rear direction of the refrigerator 1, although not limited thereto. However, the supply cover 300 may be formed in various ways.

The supply cover 300 may include a cover body 340, and the accommodating groove 310 formed inside the cover body 340.

The accommodating groove 310 may accommodate at least a portion of the supply member 200. The accommodating groove 310 may enable at least a portion of the supply member 200 to be located at a side of the hinge bracket 120. The supply member 200 may be accommodated in the accommodating groove 310 and at least a portion of the supply member 200 may be located at the side of the hinge bracket 120, covered by the supply cover 300.

The accommodating groove 310 may be covered by the hinge bracket 120. The accommodating groove 310 may be covered by an outer side of the main body 10.

Details about a configuration of the accommodating groove 310 will be described below.

The cover body 340 may be located at a side of the hinge bracket 120, and cover the side of the hinge bracket 120. The cover body 340 may be fixed to the hinge bracket 120.

The cover body 340 may be located on a side of the main body 10, and cover a side of a portion of the main body 10. The cover body 340 may be fixed to the main body 10.

The cover body 340 may include a bracket cover portion 341 that covers the hinge bracket 120. The bracket cover portion 341 may be opposite to the hinge bracket 120.

The bracket cover portion 341 may cover a portion of the supply member 200 positioned along the hinge bracket 120.

The cover body 340 may include a body cover portion 342 that covers a portion of the main body 10. The body cover portion 342 may be opposite to a portion of the outer surface of the main body 10.

The body cover portion 342 may cover a portion of the supply member 200 positioned along the outer surface (for example, the base 12c) of the main body 10.

The bracket cover portion 341 may be connected to the body cover portion 342. The bracket cover portion 341 may be located in the front direction of the body cover portion 342. The body cover portion 342 may extend in a rear direction from a rear end of the bracket cover portion 341. The bracket cover portion 341 and the body cover portion 342 may be integrated into one body.

A portion of the supply member 200 accommodated in the accommodating groove 310 may be positioned between the bracket cover portion 341 and the hinge bracket 120. For example, as shown in FIGS. 7 to 9, the portion of the supply member 200 accommodated in the accommodating groove 310 may be located above the bracket cover portion 341 and below the hinge bracket 120. For example, unlike FIGS. 7 to 9, the portion of the supply member 200 accommodated in the accommodating groove 310 may be located below the bracket cover portion 341 and above the hinge bracket 120.

Another portion of the supply member 200, accommodated in the accommodating groove 310 may be positioned between the body cover portion 342 and the main body 10. For example, as shown in FIGS. 7 to 9, the other portion of the supply member 200, accommodated in the accommodating groove 310 may be located above the main cover portion 342 and below the hinge bracket 120. For example, unlike FIGS. 7 to 9, the other portion of the supply member 200, accommodated in the accommodating groove 310 may be located below the body cover portion 342 and above the hinge bracket 120.

The supply cover 300 may include an accommodating groove opening 343 formed along a perimeter of the accommodating groove 310. The accommodating groove opening 343 may be formed at an end of the supply cover 300 toward the hinge bracket 120 and the main body 10.

For example, as shown in FIGS. 7 to 9, the accommodating groove opening 343 may be provided along an upper perimeter of the supply cover 300. An upper side of the supply cover 300 may open by the accommodating groove opening 343. An upper side of the accommodating groove 310 may open by the accommodating groove opening 343.

For example, unlike FIGS. 7 to 9, the accommodating groove opening 343 may be provided along a lower perimeter of the supply cover 300. A lower side of the supply cover 300 may open by the accommodating groove opening. A lower side of the accommodating groove 310 may open by the accommodating groove opening 343.

At least a portion of the accommodating groove opening 343 may be in contact with the hinge bracket 120 and the main body 10. That is, the accommodating groove 310 may be covered by the hinge bracket 120 and the main body 10.

The supply cover 300 may include a side wall portion 345 that covers at least a portion of the supply member 200 in the lateral direction. The side wall portion 345 may form an inner wall of the accommodating groove 310. The side wall portion 345 may cover the accommodating groove 310 in the lateral direction.

The side wall portion 345 may extend from the bracket cover portion 341 toward the hinge bracket 120. The side wall portion 345 may extend from the bracket cover portion 341 and be in contact with the hinge bracket 120. An end of the side wall portion 345, which is in contact with the hinge bracket 120, may constitute a part of the accommodating groove opening 343.

The side wall portion 345 may extend from the body cover portion 342 toward the outer surface of the main body 10. The side wall portion 345 may extend from the body cover portion 342 and be in contact with the outer surface of the main body 10. An end of the side wall portion 345, which is in contact with the outer surface of the main body 10, may constitute a part of the accommodating groove opening 343.

The supply cover 300 may include a bracket support portion 346 formed to support the supply cover 300 to the hinge bracket 120. The bracket support portion 346 may be bent at an end of the side wall portion 345 toward the hinge bracket 120 and extend. The bracket support portion 346 may be in contact with a side of the hinge bracket 120.

The bracket support portion 346 may extend in parallel to a portion of the hinge bracket 120. For example, the bracket support portion 346 may extend in parallel to a horizontal direction of the refrigerator 1. The bracket support portion 346 may extend in parallel to the hinge bracket 120 in the accommodating groove opening 343.

At least a portion of a body support portion 347 may be fixed to the outer surface of the main body 10. For example, at least a portion of the body support portion 347 may be screwed to the main body 10.

The supply cover 300 may include the body support portion 347 formed to support the supply cover 300 to the main body 10. The body support portion 347 may be bent from an end of the side wall portion 345 toward the main body 10 and extend. The body support portion 347 may be in contact with a side of a portion of the main body 10.

The body support portion 347 may extend in parallel to a portion of the outer surface of the main body 10. For example, the body support portion 347 may extend in parallel to the horizontal direction of the refrigerator 1. The body support portion 347 may extend from the accommodating groove opening 343 in parallel to the outer surface of the main body 10.

By the bracket support portion 346, the supply cover 300 may be more stably supported on the hinge bracket 120. By the body support portion 347, the supply cover 300 may be more stably supported on the outer surface of the main body 10.

By the above-described configuration, the supply cover 300 according to an embodiment of the present disclosure may guide a position of the supply member 200 connected to the door 30 and the main body 10. In addition, the supply cover 300 may protect the supply member 200 and prevent the supply member 200 from being damaged by an external impact.

The refrigerator 1 may include a door cover member 400 that covers the door supply portion 31. The door cover member 400 may be coupled to a side of the door 30. The door cover member 400 may be positioned in a side of the door supply portion 31.

For example, as shown in FIGS. 7 to 9, the door cover member 400 may be coupled to the lower side of the door 30. The door cover member 400 may be positioned below the door supply portion 31.

For example, unlike FIGS. 7 to 9, the door cover member 400 may be coupled to the upper side of the door 30. The door cover member 400 may be positioned above the door supply portion 31.

The door cover member 400 may cover a portion of the supply member 200. More specifically, the door cover member 400 may cover at least an end of the supply member 200 connected to the door supply portion 31.

The door supply portion 31 may be formed at a location spaced from the hinge shaft 110. Correspondingly, the door cover member 400 may be positioned at a location spaced from the hinge shaft 110. Accordingly, the door supply portion 31 and the door cover member 400 may be rotatable about the hinge shaft 110.

The door cover member 400 may include a door cover space 410 formed therein. A portion of the supply member 200 may be positioned in the door cover space 410. More specifically, at least an end of the supply member 200 connected to the door supply portion 31 may be positioned in the door cover space 410.

A side of the door cover space 410 toward the door supply portion 31 may open. Accordingly, the door cover space 410 may communicate with the door supply portion 31.

More specifically, the door cover member 400 may include a door-side opening 420 formed toward the door 30. The door-side opening 420 may face the door supply portion 31. The door-side opening 420 may be positioned along a perimeter of the door supply groove 31a.

The supply member 200 may penetrate the door-side opening 420. The supply member 200 may penetrate the door-side opening 420 in the door cover space 410 and extend toward the door connector 31b.

The door cover space 410 may open at a side toward the supply cover 300. Accordingly, the supply member 200 which has penetrated the first through hole 320 of the supply cover 300 may extend into the door cover space 410. In other words, the door cover member 400 may open at a side toward a guide portion 344 which will be described below.

More specifically, the door cover member 400 may include a supply member-side opening 430 formed at the side toward the supply cover 300. The supply member-side opening 430 may face the supply cover 300. More specifically, the supply member-side opening 430 may face the guide portion 344.

The supply member 200 may penetrate the supply member-side opening 430. The supply member 200 may penetrate the door-side opening 420 in the accommodating groove 310 and extend toward the door connector 31b.

The door cover member 400 may be formed with a shape that opens at the side toward the guide portion 344 and is closed at the opposite side.

The door cover member 400 may include an inclined surface 440 formed in an inner side of the door cover member 400. The inclined surface 440 may form a portion of an inner wall of the door cover space 410. The inclined surface 440 may be positioned between the supply cover-side opening 430 and the door connector 31b of the door supply portion 31. The inclined surface 440 may guide a portion of the supply member 200 that has penetrated the supply cover-side opening 430 and extends to the door connector 31b.

The door cover member 400 may be fixed to a side of the door 30 at which the door supply portion 31 is provided. For example, the door cover member 400 may be fixed to the side of the door 30 by hook coupling. A hook of the door cover member 400 may be positioned at an edge of the door-side opening 420. For example, the door cover member 400 may be fixed to the side of the door 30 by fastening with a screw.

By the above-described configuration, the door cover member 400 according to an embodiment of the present disclosure may protect the supply member 200 and prevent the supply member 200 from being damaged by an external impact.

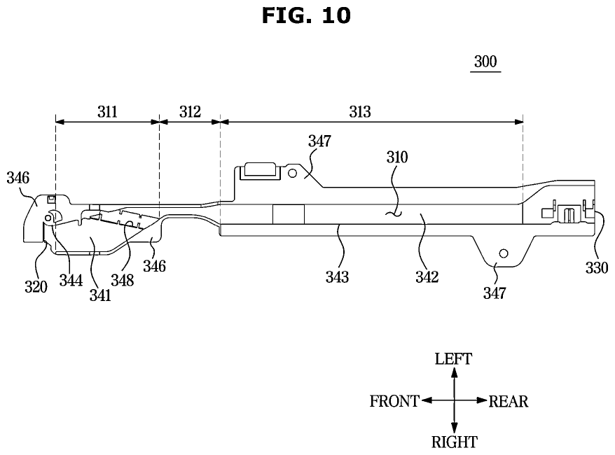

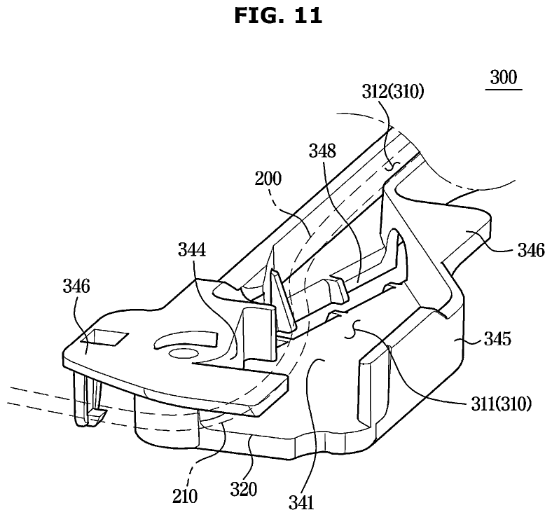

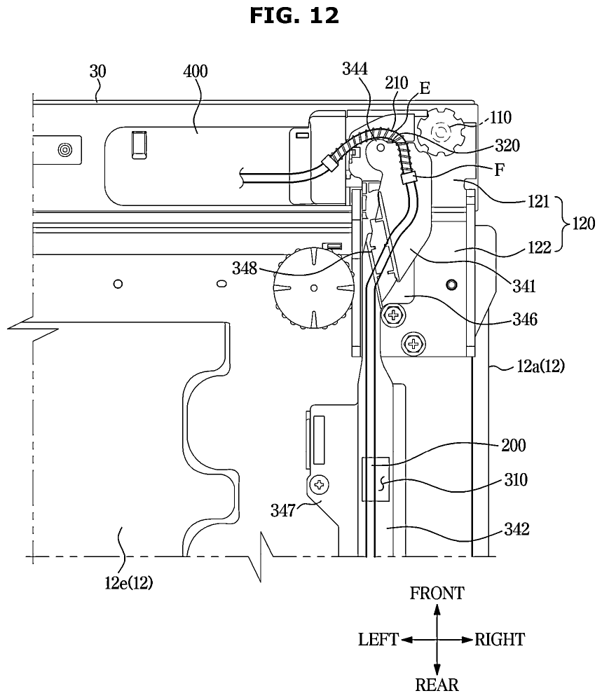

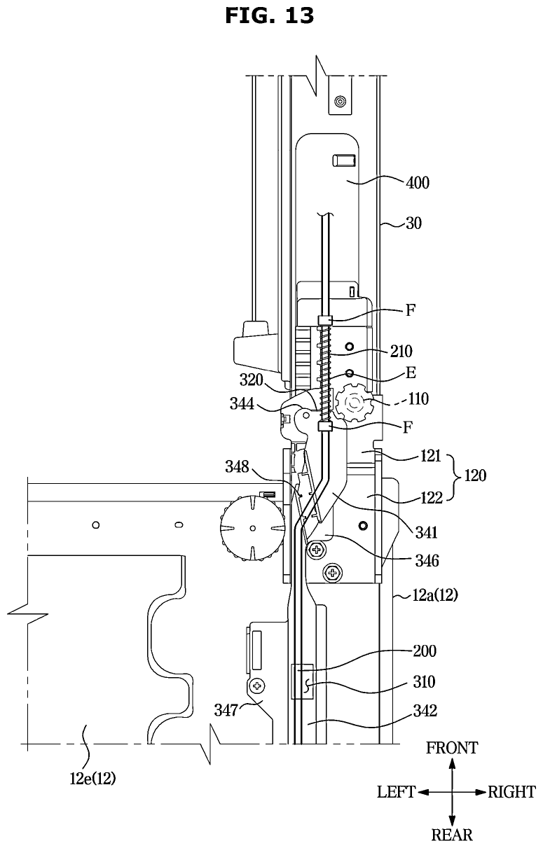

FIG. 10 shows a supply cover of a refrigerator according to an embodiment of the present disclosure. FIG. 11 is an exploded view of a portion of a supply cover in a refrigerator according to an embodiment of the present disclosure. FIG. 12 is a bottom view of a refrigerator according to an embodiment of the present disclosure, while a door is closed. FIG. 13 is a bottom view of a refrigerator according to an embodiment of the present disclosure, while a door opens.

As described above, while the door 30 is opened or closed by rotating about the hinge shaft 110, at least a portion of the supply member 200 may move in position. Particularly, according to opening or closing of the door 30, a bending angle of the bending portion 210 of the supply member 200 may change.

Referring to FIGS. 10 to 13, the supply cover 300 may include a guide portion 344 for supporting the bending portion 210. More specifically, the supply cover 300 may support the bending portion 210 while the door 30 is closed. The guide portion 344 may guide the bending portion 210 to be bent and move while the door 30 is closed.

The bending portion 210 may penetrate the first through hole 320. As shown in FIGS. 12 and 13, the bending portion 210 may penetrate the first through hole 320 and extend from the accommodating groove 310 to the door supply portion 31.

As shown in FIG. 13, while the door 30 is in an open position, the bending portion 210 may be spaced from the guide portion 344.

As shown in FIG. 12, while the door 30 moves to a closed position, a portion of the supply member 200 connected to the door supply portion 31, particularly, an end of the supply member 200 may move in a direction corresponding to a rotation direction of the door 30, and the bending portion 210 may be bent correspondingly.

The first through hole 320 may be located between the guide portion 344 and the hinge shaft 110. While the door 30 is in the closed position, a portion of the supply member 200 which has penetrated the first through hole 320 may extend in an opposite direction of the hinge shaft 110, be supported on the guide portion 344, and extend toward the door supply portion 31.

The guide portion 344 may be positioned between the door supply portion 31 and the hinge shaft 110.

The guide portion 344 may be located in a direction toward the second side wall 12b from the first side wall 12a with respect to an end of the accommodating groove 310 toward the door 30. In other words, the guide portion 344 may be located in a direction toward the second side wall 12b which is opposite to the first side wall 12a from the first side wall 12a adjacent to the hinge shaft 110 with respect to the first through hole 320.

In this case, the supply member 200 may be connected to the door supply portion 31 without interfering with the hinge shaft 110, although not limited thereto.

However, the guide portion 344 may be located between the hinge shaft 110 and the first through hole 320.

By the above-described configuration, as shown in FIGS. 11 and 12, while the door 30 moves to the closed position, the bending portion 210 may be bent toward the guide portion 344. In other words, the bending portion 210 may move toward the guide portion 344. At this time, the bending portion 210 may contact the guide portion 344 and be supported by the guide portion 344. The bending portion 210 may be positioned along a perimeter of the guide portion 344, and bending of the bending portion 210 may be guided by the guide portion 344. Accordingly, the bending portion 210 may be prevented from being damaged due to a movement of the bending portion 210 according to opening or closing of the door 30.

The guide portion 344 may be formed with a curved shape. In this case, the bending portion 210 may be bent to a shape corresponding to the curved shape of the guide portion 344. Accordingly, the guide portion 344 may effectively prevent the being portion 210 from being damaged, although not limited thereto. However, the guide portion 344 may be formed with various shapes.

The accommodating groove 310 may include a bracket area 311 provided inside the bracket cover portion 341 and a body area 313 provided inside the body cover portion 342.

The bracket area 311 may face the hinge bracket 120. The bracket area 311 may be covered by the hinge bracket 120. A portion of the supply member 200 covered by the bracket cover portion 341 may be accommodated in the bracket area 311. A portion of the supply member 200 positioned along the hinge bracket 120 may be accommodated in the bracket area 311.

The body area 313 may face the outer surface of the main body 10. The body area 313 may be covered by the outer surface of the main body 10. A portion of the supply member 200 covered by the body cover portion 342 may be accommodated in the body area 313.

The bracket area 311 may be positioned adjacent to the first through hole 320. The bracket area 311 may be positioned between the first through hole 230 and the body area 313. A portion of the supply member 200 may penetrate the first through hole 320 from the bracket area 311 and extend to the door supply portion 31. The bracket area 311 may be located between the body area 313 and the guide portion 344.

For example, the bracket area 311 may be located in front of the body area 313.

The bracket area 311 may be positioned adjacent to the bending portion 210. While the door 30 rotates about the hinge shaft 110, a portion of the supply member 200 accommodated in the bracket area 311 may move relatively greatly than the other portion.

The bracket area 311 may be formed with a wider width than the body area 313. Accordingly, the portion of the supply member 200 accommodated in the bracket area 311 may be effectively prevented from being interfered with while the portion moves as the door 30 is opened or closed. Also, because the body area 313 has a narrower width than the bracket area 311, the portion of the supply member 200 accommodated in the body area 313 may be effectively prevented from moving.

The accommodating groove 310 may include a middle area 312 formed between the body area 313 and the bracket area 311. The middle area 312 may be formed with a narrower width than the body area 313. A portion of the supply member 200 accommodated in the middle area 312 may be effectively prevented from moving.

The bracket area 311, the middle area 312, and the body area 313 may be arranged in the front-rear direction of the refrigerator 1. The bracket area 311 may be located in front of the middle area 312, and the middle area 312 may be located in front of the body area 313.

The bracket area 311, the middle area 312, and the body area 313 may extend in the front-rear direction of the refrigerator 1, although not limited thereto.

However, the accommodating groove 310 may be formed with various shapes capable of accommodating at least a portion of the supply member 200.

The refrigerator 1 may further include an elastic spring E surrounding an outer circumferential surface of the bending portion 210. The elastic spring E may cover the outer circumferential surface of the bending portion 210. The elastic spring E may provide an elastic force to more efficiently prevent the bending portion 210 from being damaged.

The elastic spring E may be bendable together with the bending portion 210 according to opening or closing of the door 30.

The elastic spring E may be supported by the guide portion 344 while the door 30 is closed.

The elastic spring E may be fixed to the outer surface of the bending portion 210 by a fixing member F provided at both ends of the elastic spring E. The fixing member F may be configured by including various materials, such as plastic, rubber, adhesive tape, etc., as long as the fixing member F is provided at both ends of the elastic spring E and fixes the elastic spring E to the bending portion 210, although not limited thereto.

However, the bending portion 210 may include various components to prevent damage. For example, the outer circumferential surface of the bending portion 210 may be covered by a component of an elastic material such as rubber.

As described above, the refrigerator 1 according to an embodiment of the present disclosure may include the supply member 200 to supply power or water from the main body 10 toward the door 30. Also, the refrigerator 1 may include the supply cover 300 to guide a position of the supply member 200 and prevent the supply member 200 from being damaged by an external impact, bending of the supply member 200, etc.

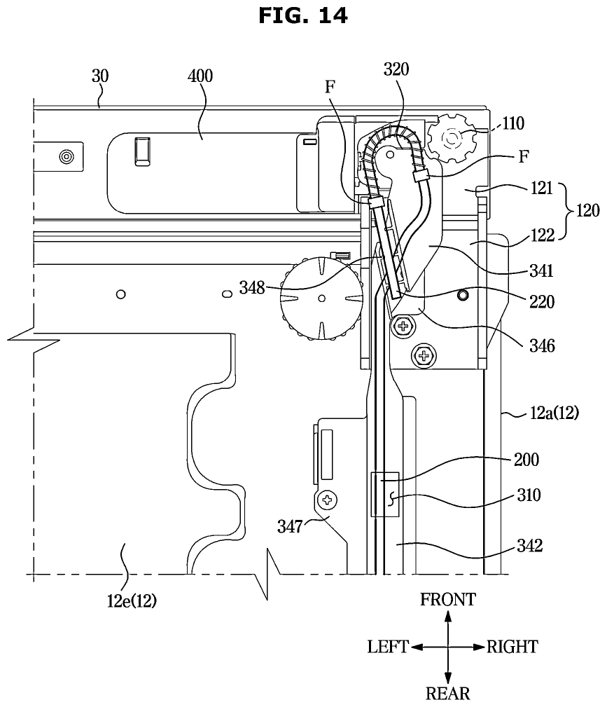

FIG. 14 shows a state before a supply member is connected to a door in a refrigerator according to an embodiment of the present disclosure.

Referring to FIG. 14, the supply cover 300 may include a supply member fixing hole 348 for fixing a portion of the supply member 200 separated from the door 30.

More specifically, the supply member 200 may be separated from the door supply portion 31, more specifically, the door connector 31b. For example, the supply member 200 may need to be separated from the door connector 31b during a manufacturing stage of the refrigerator 1, a transportation stage of the refrigerator 1, a component repair or inspection stage of the refrigerator 1, etc.

While the refrigerator 1 is used, an end 220 of the supply member 200 connected to the door connector 31b may be separated from the door connector 31b as necessary. In this case, if the end 220 of the supply member 200 is not supported by a separate structure, there is a risk of damage due to an external impact, etc.

To overcome this problem, the supply cover 300 may include the supply member fixing hole 348. The supply member fixing hole 348 may be formed in the cover body 340. The supply member fixing hole 348 may be formed with a shape penetrating the cover body 340 from one side.

For example, the supply member fixing hole 348 may be formed in the bracket cover portion 341. The supply member fixing hole 248 may be formed with a shape penetrating the bracket cover portion 341.

A protrusion for more firmly fixing the end 220 of the supply member 200 may be formed at an edge of the supply member fixing hole 348, although not limited thereto.

However, the refrigerator 1 may include various configurations for fixing the end of the supply member 200 separated from the door connector 31b.

According to an aspect of the present disclosure, a refrigerator may include a supply member connected to a door and a main body to supply power or water to a component of the refrigerator, installed in the door.

According to an aspect of the present disclosure, a refrigerator may include a supply cover for covering a supply member connected to a door and a main body to guide a position of the supply member.

According to an aspect of the present disclosure, a refrigerator may include a supply cover for covering a supply member to protect the supply member and prevent the supply member from being damaged by an external impact.

According to an aspect of the present disclosure, a refrigerator may include a supply cover including a guide portion that supports a bendable portion of a supply member to prevent the supply member from being damaged according to opening or closing of a door.

According to an aspect of the present disclosure, a refrigerator may include a bracket area having a wide width to prevent interference with a movement of a supply member according to opening or closing of a door within the bracket area.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A refrigerator comprising:
a main body comprising a storage chamber;
a door configured to open or close the storage chamber;
a hinge bracket supporting the door such that the door is rotatable about a hinge shaft with respect to the main body;
a supply member comprising at least one of a wire or a pipe, and connected to the main body and the door; and
a supply cover covering at least a portion of the supply member and a side of the hinge bracket, the supply cover being penetrated by the supply member,
wherein the supply member comprises a bending portion configured to be bendable according to opening or closing of the door, and
wherein the supply cover comprises a guide portion configured to support the bending portion in a state in which the door is closed.

2. The refrigerator of claim 1, wherein
the supply cover further comprises a through hole which the bending portion penetrates, and
wherein the through hole is between the guide portion and the hinge shaft.

3. The refrigerator of claim 2, wherein
the through hole has a shape that opens in a front-rear direction of the main body.

4. The refrigerator of claim 1, wherein
the supply cover further comprises an accommodating groove configured to accommodate the at least a portion of the supply member at the side of the hinge bracket.

5. The refrigerator of claim 4, wherein
the supply cover further comprises an accommodating groove opening along a perimeter of the accommodating groove, and
wherein at least a portion of the accommodating groove opening is in contact with the hinge bracket and the main body.

6. The refrigerator of claim 4, wherein
the supply cover further comprises a bracket cover portion covering the side of the hinge bracket, and a body cover portion covering a side of the main body,
wherein the accommodating groove comprises:
a body area provided inside the body cover portion, and
a bracket area provided inside the bracket cover portion and having a wider width than the body area, and
wherein the bracket area is between the body area and the guide portion.

7. The refrigerator of claim 6, wherein
the accommodating groove further comprises a middle area between the body area and the bracket area, and
wherein the middle area is has a narrower width than the body area.

8. The refrigerator of claim 4, wherein
a lateral direction is perpendicular to a direction in which the hinge shaft extends and a front-rear direction of the main body,
wherein the main body comprises a first side wall forming a surface adjacent to the hinge shaft in the lateral direction, and a second side wall forming a second surface in the lateral direction, and
wherein the guide portion is oriented in a direction toward the second side wall from the first side wall with respect to an end of the accommodating groove toward the door.

9. The refrigerator of claim 1, further comprising
an elastic spring surrounding an outer circumferential surface of the bending portion,
wherein the elastic spring is supported by the guide portion in the state in which the door is closed.

10. The refrigerator of claim 1, wherein
the door comprises a door supply portion provided in a side of the door and connected to the supply member,
wherein the refrigerator further comprises a door cover member covering the door supply portion, and
wherein the door supply portion and the door cover member are rotatable about the hinge shaft.

11. The refrigerator of claim 10, wherein
the guide portion is between the door supply portion and the hinge shaft.

12. The refrigerator of claim 11, wherein
the door cover member has a shape in which a side toward the guide portion is opened and a second side is closed.

13. The refrigerator of claim 1, wherein
the guide portion has a curved shape.

14. The refrigerator of claim 1, wherein
the hinge bracket comprises a door coupling portion coupled to the door, and
wherein the supply cover is fixed to the door coupling portion and the main body.

15. The refrigerator of claim 1, wherein
the supply cover further comprises:
a bracket cover portion opposite to the hinge bracket and covering the hinge bracket,
a side wall portion extending from the bracket cover portion toward the hinge bracket and being in contact with the hinge bracket, and
a bracket support portion extending from an end of the side wall portion in a direction parallel to the hinge bracket, and
wherein the bracket support portion is in contact with a side of the hinge bracket such that the supply cover is supported on the hinge bracket.
